(19) United States
(12) Patent Application Publication
(10) Pub. No.: US 2017/0064018 A1
(43) Pub. Date: Mar. 2, 2017

(54) PROVIDING RELEVANT CONTENT TO A USER DURING A USER'S FREE TIME

(71) Applicant: International Business Machines Corporation, Armonk, NY (US)

(72) Inventors: Paul R. Bastide, Boxford, MA (US); Matthew E. Broomhall, Goffstown, NH (US); Robert E. Loredo, North Miami Beach, FL (US)

(21) Appl. No.: 14/834,688

(22) Filed: Aug. 25, 2015

(51) Int. Cl. H04L 29/08

(52) U.S. Cl. CPC H04L 67/22; H04L 67/327

(57) ABSTRACT

A method, system and computer program product for utilizing a user's free time. A period of free time for the user is identified. A user's request to access an application (e.g., social media application), a view and/or a folder is monitored during the user's period of free time. In response to detecting no content updates when the user accesses the application, view and/or folder during the user's free time, content is selected to be displayed to the user during the user's free time. For example, opportunistic content, such a password change notification, may be displayed to the user five days prior to the normal time of notification. In this manner, the user will be able to address such content during a time the user has free as opposed to being required to address such content when the user has less free time thereby more efficiently utilizing the user's free time.

### TECHNICAL FIELD

The present invention relates generally to social network services, and more particularly to utilizing a user's free time by displaying relevant content, such as opportunistic content, existing content and advertising content, to the user during the user's free time.

### BACKGROUND

A social network service is an online service, platform or site that focuses on building social networks or social relations among people (e.g., those who share interests and/or activities). A social network service essentially consists of a representation of each user (often a profile), his/her social links, and a variety of additional services. Most social network services are web-based and provide means for users to interact over the Internet, such as by e-mail and instant messaging. Social networking sites allow users to share ideas, activities, events, and interests within their individual networks.

Social networking sites (e.g., Facebook®) present to a particular user the posts and stories by other users in a social networking feed or activity stream (may be referred to as a “news feed”). New postings or updates from friends and pages followed by the user (including photo tags, event updates, group memberships and other activity) will be reflected in the user's activity stream. Users often refresh their social media application (e.g., Facebook®), such as during the user's free time, to check their activity stream to find out if he/she received any new posts or news from the time the user last viewed the activity stream. Users may also refresh other applications during their free time, such as their e-mail application or instant messaging application, to find out if he/she received any new messages from the last time the user viewed the application.

There may be times when there are no updates (e.g., no new post, no new message) to be displayed to the user after the user refreshes the application (e.g., social media application), such as during the user's free time. Later, however, the user may be inundated with new posts, messages and news, such as during the time when the user does not have much free time. In such a situation, the user's free time went unutilized when the user had time to review and respond to the updates.

As a result, the user's free time is not being efficiently utilized, such as during the times when the user has no updates to respond.

### BRIEF SUMMARY

In one embodiment of the present invention, a method for utilizing a user's free time comprises identifying a period of free time for the user. The method further comprises monitoring an application, view and/or folder to be accessed by the user during the period of free time of the user. The method additionally comprises detecting no content updates in the application, view and/or folder accessed by the user during the period of free time of the user in comparison to a prior time the user accessed the application, view and/or folder. Furthermore, the method comprises selecting, by a processor, content to be presented to the user in response to the detection of no content updates in the application, view and/or folder during the period of free time of the user, where the selected content comprises one or more the following: opportunistic content, existing content and advertising content. Additionally, the method comprises displaying the selected content to the user during the period of free time of the user.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a communication system configured in accordance with an embodiment of the present invention;

FIG. 2 illustrates a hardware configuration of a computing device in accordance with an embodiment of the present invention;

FIG. 3 is a flowchart of a method for utilizing the user's free time by displaying to the user relevant content, such as opportunistic content, existing content and advertising content, during the user's free time in accordance with an embodiment of the present invention; and

FIG. 4 is a flowchart of a method for displaying the relevant content to the user in order of priority during the user's free time in accordance with an embodiment of the present invention.

### DETAILED DESCRIPTION

The present invention comprises a method, system and computer program product for utilizing a user's free time. In one embodiment of the present invention, a period of free time for the user is identified. For example, the user's free time may be identified by detecting the time that the user is free in the user's calendar application. A user's request to access an application (e.g., social media application, e-mail application, instant messaging application, project management application, forum), a view and/or a folder is monitored during the user's identified period of free time. In response to detecting no content updates when the user accesses the application, view and/or folder during the user's identified period of free time, content (e.g., opportunistic content, existing content, advertising content) is selected to be displayed to the user during the user's free time. For example, opportunistic content, such a password change notification, may be displayed to the user five days prior to the normal time of notifying the user regarding changing the user's password. In this manner, the user will be able to address such content during a time the user has free as opposed to possibly being required to address such content when the user has less free time. As a result, the user's free time is more efficiently utilized.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

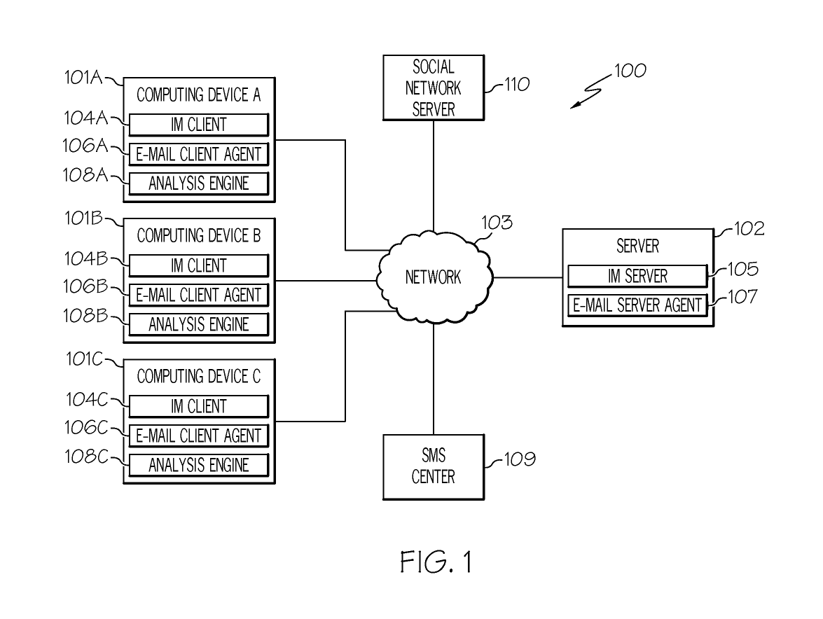

Referring now to the Figures in detail, FIG. 1 illustrates a communication system 100 for practicing the principles of the present invention in accordance with an embodiment of the present invention. Communication system 100 includes computing devices 101A-101C (identified as “Computing Device A,” “Computing Device B,” and “Computing Device C,” respectively, in FIG. 1) connected to a server 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with other computing devices 101 and server 102.

Computing devices 101 may be configured to send and receive text-based messages in real-time during an instant messaging session. Any user of computing devices 101 may be the creator or initiator of an instant message (message in instant messaging) and any user of computing devices 101 may be a recipient of an instant message. Furthermore, any user of computing devices 101 may be able to create, receive and send e-mails. Additionally, any user of computing devices 101 may be able to send and receive text messages, such as Short Message Services (SMS) messages.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In communication system 100, computing devices 101A-101C include a software agent, referred to herein as an “Instant Messaging (IM) client” 104A-104C, respectively. Instant messaging clients 104A-104C may collectively or individually be referred to as instant messaging clients 104 or instant messaging client 104, respectively. Furthermore, server 102 includes a software agent, referred to herein as the “Instant Messaging (IM) server” 105. IM client 104 provides the functionality to send and receive instant messages. As messages are received, IM client 104 presents the messages to the user in a dialog window (or IM window). Furthermore, IM client 104 provides the functionality for computing device 101 to connect to the IM server 105 which provides the functionality of distributing the instant messages to the IM clients 104 associated with each of the sharing users.

Computing device 101A-101C may further include a software agent, referred to herein as an “e-mail client agent” 106A-106C, respectively. E-mail client agents 106A-106C may collectively or individually be referred to as e-mail client agents 106 or e-mail client agent 106, respectively. Furthermore, server 102 may include a software agent, referred to herein as the “e-mail server agent” 107. E-mail client agent 106 enables the user of computing device 101 to create, send and receive e-mails. E-mail server agent 107 is configured to receive e-mail messages from computing device 101 and distribute the received e-mail messages among the one or more computing devices 101.

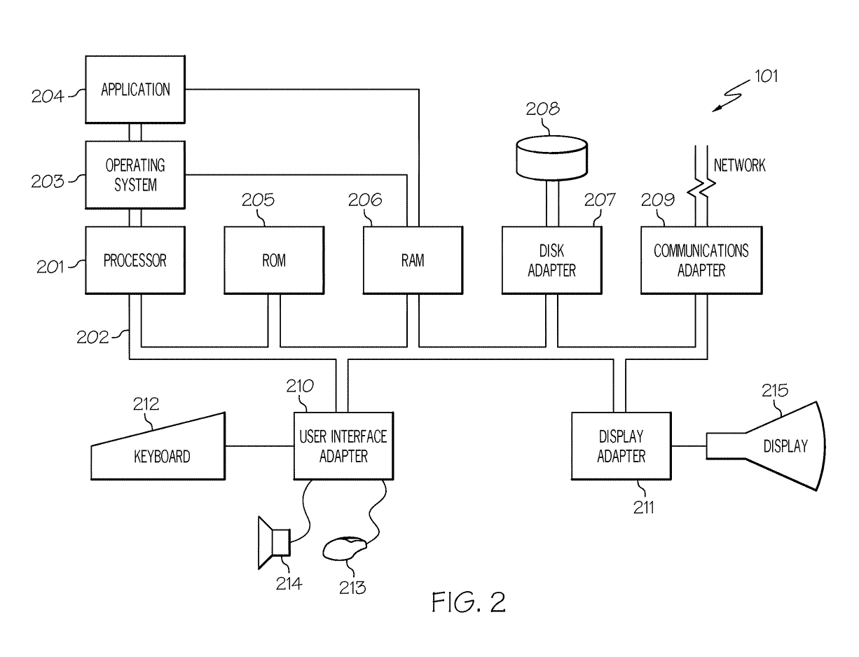

Furthermore, computing devices 101A-101C may include a software agent, referred to herein as the “analysis engine” 108A-108C, respectively, configured to utilize a user's free time by displaying relevant content, such as opportunistic content, existing content and advertising content, to the user (e.g., user of computing device 101A) during the user's free time. A description of the hardware configuration of computing device 101 is provided below in connection with FIG. 2.

While the preceding discusses each computing device 101 as including an IM client 104, an e-mail client agent 106 and an analysis engine 108, each computing device 101 may not necessarily include each of these software agents. Furthermore, while the preceding discusses a single server 102 including the software agents, such as IM server 105 and e-mail server agent 107, multiple servers may be used to implement these services. Furthermore, each server 102 may not necessarily be configured to include all of these software agents, but only a subset of these software agents.

System 100 further includes a Short Message Service (SMC) center 109 configured to relay, store and forward text messages, such as SMS messages, among computing devices 101 through network 103.

System 100 further includes a social network server 110, which may be a web server configured to offer a social networking and/or microblogging service, enabling users of computing devices 101 to send and read other users' posts. “Posts,” as used herein, include any one or more of the following: text (e.g., comments, sub-comments and replies), audio, video images, etc. Social network server 110 is connected to network 103 by wire or wirelessly. While FIG. 1 illustrates a single social network server 110, it is noted for clarity that multiple servers may be used to implement the social networking and/or microblogging service.

System 100 is not to be limited in scope to any one particular network architecture. System 100 may include any number of computing devices 101, servers 102, networks 103, SMS centers 109 and social network servers 110.

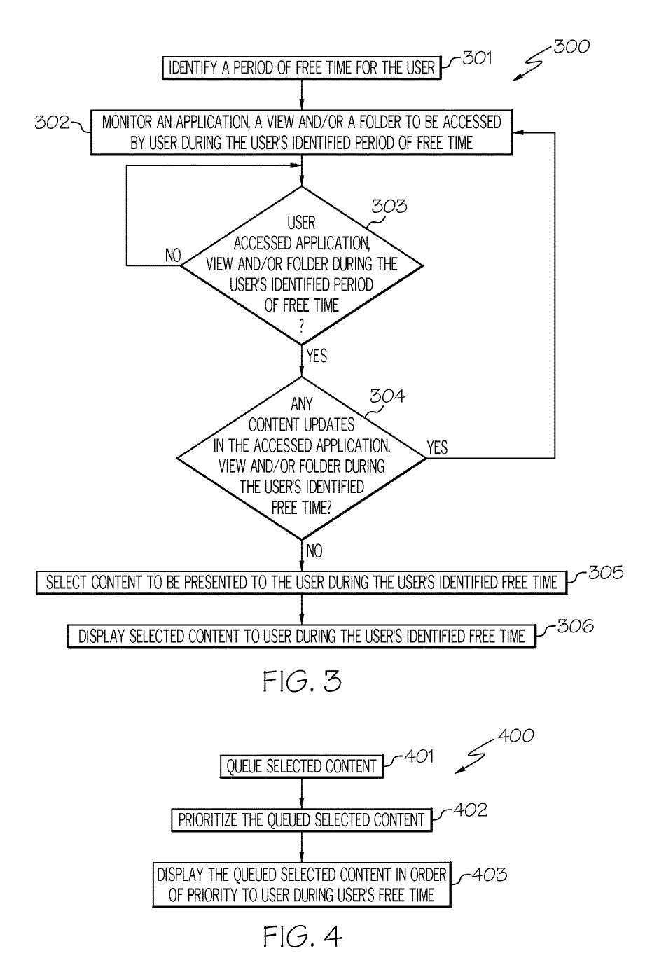

Referring now to FIG. 2, FIG. 2 illustrates a hardware configuration of computing device 101 (FIG. 1) which is representative of a hardware environment for practicing the present invention. Referring to FIG. 2, computing device 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, analysis engine 108 for utilizing a user's free time by displaying relevant content, such as opportunistic content, existing content and advertising content, to the user (e.g., user of computing device 101A) during the user's free time as discussed further below in connection with FIGS. 3-4.

Referring again to FIG. 2, read-only memory (“ROM”) 205 is coupled to system bus 202 and includes a basic input/output system (“BIOS”) that controls certain basic functions of computing device 101. Random access memory (“RAM”) 206 and disk adapter 207 are also coupled to system bus 202. It should be noted that software components including operating system 203 and application 204 may be loaded into RAM 206, which may be computing device's 101 main memory for execution. Disk adapter 207 may be an integrated drive electronics (“IDE”) adapter that communicates with a disk unit 208, e.g., disk drive.

Computing device 101 may further include a communications adapter 209 coupled to bus 202. Communications adapter 209 interconnects bus 202 with an outside network thereby enabling computing device 101 to communicate with other devices (e.g., other computing devices 101, server 102, SMS center 109, social network server 110).

I/O devices may also be connected to computing device 101 via a user interface adapter 210 and a display adapter 211. Keyboard 212, mouse 213 and speaker 214 may all be interconnected to bus 202 through user interface adapter 210. A display monitor 215 may be connected to system bus 202 by display adapter 211. In this manner, a user is capable of inputting to computing device 101 through keyboard 212 or mouse 213 and receiving output from computing device 101 via display 215 or speaker 214. Other input mechanisms may be used to input data to computing device 101 that are not shown in FIG. 2, such as display 215 having touch-screen capability and keyboard 212 being a virtual keyboard. Computing device 101 of FIG. 2 is not to be limited in scope to the elements depicted in FIG. 2 and may include fewer or additional elements than depicted in FIG. 2.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, social networking sites (e.g., Facebook®) present to a particular user the posts and stories by other users in a social networking feed or activity stream (may be referred to as a “news feed”). New postings or updates from friends and pages followed by the user (including photo tags, event updates, group memberships and other activity) will be reflected in the user's activity stream. Users often refresh their social media application (e.g., Facebook®), such as during the user's free time, to check their activity stream to find out if he/she received any new posts or news from the time the user last viewed the activity stream. Users may also refresh other applications during their free time, such as their e-mail application or instant messaging application, to find out if he/she received any new messages from the last time the user viewed the application. There may be times when there are no updates (e.g., no new post, no new message) to be displayed to the user after the user refreshes the application (e.g., social media application), such as during the user's free time. Later, however, the user may be inundated with new posts, messages and news, such as during the time when the user does not have much free time. In such a situation, the user's free time went unutilized when the user had time to review and respond to the updates. As a result, the user's free time is not being efficiently utilized, such as during the times when the user has no updates to respond.

The principles of the present invention provide a means for utilizing the user's free time by displaying to the user (e.g., user of computing device 101A) relevant content, such as opportunistic content, existing content and advertising content, during the user's free time as discussed below in connection with FIGS. 3 and 4. FIG. 3 is a flowchart of a method for utilizing the user's free time by displaying to the user relevant content, such as opportunistic content, existing content and advertising content, during the user's free time. FIG. 4 is a flowchart of a method for displaying the relevant content to the user in order of priority during the user's free time.

As stated above, FIG. 3 is a flowchart of a method 300 for utilizing the user's free time by displaying to the user (e.g., user of computing device 101A) relevant content, such as opportunistic content, existing content and advertising content, during the user's free time in accordance with an embodiment of the present invention.

Referring to FIG. 3, in conjunction with FIGS. 1-2, in step 301, analysis engine 108 identifies a period of free time for the user (i.e., the user of computing device 101). In one embodiment, the user's free time is identified by the input provided by the user. For example, the user may indicate, such as via keyboard 212, that the user has free time between 3:00 pm and 4:00 pm on Monday's. In another embodiment, the user's free time is identified by detecting the time that the user is free in the user's calendar application. In another embodiment, the user's free time is identified by detecting the time that the user is free in the user's profile.

In step 302, analysis engine 108 monitors a user's request to access an application (e.g., social media application, e-mail application, instant messaging application, project management application, forum), a view and/or a folder during the user's identified period of free time. In one embodiment, such an access corresponds to the user refreshing the application, view and/or contents of the folder. For example, analysis engine 108 may detect a user's navigation to a folder and monitor the folder for the user to refresh the contents of the folder. In another example, analysis engine 108 may monitor for the user to refresh the social media application (e.g., Facebook®) on the user's computing device 101. While the following discusses the present invention in connection with monitoring an application, a view and/or a folder to be accessed by the user, the principles of the present invention may be applied to monitoring subsets of views, folders and/or applications to be accessed by the user. A person of ordinary skill in the art would be capable of applying the principles of the present invention to such implementations. Further, embodiments applying the principles of the present invention to such implementations would fall within the scope of the present invention.

In step 303, a determination is made by analysis engine 108 as to whether the user accessed an application, a view and/or a folder during the user's identified period of free time.

If the user has not yet accessed an application, a view and/or a folder during the user's identified period of free time, analysis engine 108 continues to determine whether the user accessed an application, a view and/or a folder during the user's identified period of free time in step 303.

If, however, the user has accessed an application, a view and/or a folder during the user's identified period of free time, then, in step 304, analysis engine 108 determines whether there were any content updates in the accessed application, view and/or folder during the user's identified free time in comparison to a prior time the user accessed the application, view and/or folder. For example, analysis engine 108 may determine if there were any content updates since the user last viewed the user's social network feed. In the embodiment where an “access” corresponds to a refresh of the application, view and/or folder, analysis engine 108 determines whether there were any content updates in the refreshed application, view and/or folder in response to the refresh of the application, view and/or folder.

If there were content updates in the accessed application, view and/or folder, then analysis engine 108 continues to monitor a user's request to access an application (e.g., social media application, e-mail application, instant messaging application, project management application, forum), a view and/or a folder during the user's identified period of free time in step 302.

If, however, analysis engine 108 detects that there were no content updates in the accessed application, view and/or folder during the user's identified free time in comparison to a prior time the user accessed the application, view and/or folder, then, in step 305, analysis engine 108 selects the content (e.g., opportunistic content, existing content, advertising content) to be presented to the user during the user's identified free time in response to detecting no content updates in the accessed application, view and/or folder during the user's identified free time. In this manner, the user will be able to more efficiently utilize his/her free time by acting upon relevant content as discussed below.

In one embodiment, such selected content may include what is referred to herein as “opportunistic content.” “Opportunistic content,” as used herein, refers to messages that are presented earlier than a normal time of presentation. For example, a password change notification may be displayed to the user five days prior to the normal time of notifying the user regarding changing the user's password. Other examples include subscription renewal confirmations, human resource training notifications and security patch notifications.

In another embodiment, the selected content may include existing content. For example, the existing content may include unread or unflagged messages.

By the user acting upon such content (e.g., opportunistic, existing), the user will be able to address such content during a time the user has free as opposed to possibly being required to address such content when the user has less free time.

In another embodiment, the selected content may include advertising content. For example, the advertising content may include advertisements from a set of vendors. By the user receiving such advertisements during the user's free time, the user will have more time to review the advertisement and possibly purchase the advertised good/service as opposed to receiving the advertisement during a time when the user has less free time.

In one embodiment, designated content is not selected to be displayed to the user until the user refreshes the monitored application, view and/or folder.

In step 306, analysis engine 108 displays the selected content to the user during the user's identified free time. For example, analysis engine 108 may display the selected content to the user's social network feed. Other examples include displaying the selected content in the user's e-mail or instant messaging application. The user may then act upon the displayed content item during the user's free time thereby more efficiently utilizing the user's free time.

In one embodiment, analysis engine 108 displays a limited amount of the selected content to the user after the user first accesses the application, view and/or folder during the user's free time and will display an additional amount of the selected content to the user if there is still no content updates detected upon the user further accessing the application, view and/or folder during the user's free time.

The selected content that is displayed to the user may be prioritized such that the higher prioritized content is displayed prior to the lower prioritized content to more efficiently utilize the user's free time as discussed below in connection with FIG. 4.

FIG. 4 is a flowchart of a method 400 for displaying the relevant content to the user in order of priority during the user's free time in accordance with an embodiment of the present invention.

Referring to FIG. 4, in conjunction with FIGS. 1-3, in step 401, analysis engine 108 queues the selected content (the content selected in step 305 of method 300).

In step 402, analysis engine 108 prioritizes the queued selected content. In one embodiment, the selected content is prioritized based on a user's location, a notification assigned to the selected content, a number of social media likes for the content, type of content, priorities assigned to designated content by the user in a user's profile, a sender and/or other recipients of a message and/or an estimated time to complete a task of a message.

In step 403, analysis engine 108 displays the queued selected content in the order of priority to the user during the user's free time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-8. (canceled)

9. A computer program product for utilizing a user's free time, the computer program product comprising a computer readable storage medium having program code embodied therewith, the program code comprising the programming instructions for:
identifying a period of free time for said user;
monitoring an application, view and/or folder to be accessed by said user during said period of free time of said user;
detecting no content updates in said application, view and/or folder accessed by said user during said period of free time of said user in comparison to a prior time said user accessed said application, view and/or folder;
selecting content to be presented to said user in response to said detection of no content updates in said application, view and/or folder during said period of free time of said user, wherein said selected content comprises one or more the following: opportunistic content, existing content and advertising content; and
displaying said selected content to said user during said period of free time of said user.

10. The computer program product as recited in claim 9, wherein said period of free time of said user is identified in response to one of the following: input provided by said user, detecting a time said user is free in a calendar application of said user and detecting a time said user is free in a profile of said user.

11. The computer program product as recited in claim 9, wherein the program code further comprises the programming instructions for:
monitoring said application, view and/or folder to be refreshed by said user during said period of free time of said user; and
determining whether there are any content updates in said refreshed application, view and/or folder in response to said refresh of said application, view and/or folder during said period of free time of said user.

12. The computer program product as recited in claim 9, wherein the program code further comprises the programming instructions for:
queuing said selected content;
prioritizing said queued selected content; and
displaying said queued selected content in order of priority to said user during said period of free time of said user.

13. The computer program product as recited in claim 12, wherein said prioritizing is based on one or more of the following: a user's location, a notification assigned to content, a number of social media likes, type of content, priorities assigned to designated content by said user in a profile of said user, a sender and/or other recipients of a message, and an estimated time to complete a task of a message.

14. The computer program product as recited in claim 9, wherein a designated content is not selected to be displayed to said user until said user refreshes said application, view and/or folder.

15. The computer program product as recited in claim 9, wherein said application comprises one of the following: an e-mail application, a social media application, an instant message application, a project management application, a forum.

16. The computer program product as recited in claim 9, wherein said opportunistic content comprises messages that are presented earlier than a normal time of presentation, wherein said existing content comprises unread or unflagged messages.

17. A system, comprising:
a memory unit for storing a computer program for utilizing a user's free time; and
a processor coupled to the memory unit, wherein the processor is configured to execute the program instructions of the computer program comprising:
identifying a period of free time for said user;
monitoring an application, view and/or folder to be accessed by said user during said period of free time of said user;
detecting no content updates in said application, view and/or folder accessed by said user during said period of free time of said user in comparison to a prior time said user accessed said application, view and/or folder;
selecting content to be presented to said user in response to said detection of no content updates in said application, view and/or folder during said period of free time of said user, wherein said selected content comprises one or more the following: opportunistic content, existing content and advertising content; and
displaying said selected content to said user during said period of free time of said user.

18. The system as recited in claim 17, wherein said period of free time of said user is identified in response to one of the following: input provided by said user, detecting a time said user is free in a calendar application of said user and detecting a time said user is free in a profile of said user.

19. The system as recited in claim 17, wherein the program instructions of the computer program further comprises:
monitoring said application, view and/or folder to be refreshed by said user during said period of free time of said user; and
determining whether there are any content updates in said refreshed application, view and/or folder in response to said refresh of said application, view and/or folder during said period of free time of said user.

20. The system as recited in claim 17, wherein the program instructions of the computer program further comprises:
queuing said selected content;
prioritizing said queued selected content; and
displaying said queued selected content in order of priority to said user during said period of free time of said user.

21. The system as recited in claim 20, wherein said prioritizing is based on one or more of the following: a user's location, a notification assigned to content, a number of social media likes, type of content, priorities assigned to designated content by said user in a profile of said user, a sender and/or other recipients of a message, and an estimated time to complete a task of a message.

22. The system as recited in claim 17, wherein a designated content is not selected to be displayed to said user until said user refreshes said application, view and/or folder.

23. The system as recited in claim 17, wherein said application comprises one of the following: an e-mail application, a social media application, an instant message application, a project management application, a forum.

24. The system as recited in claim 17, wherein said opportunistic content comprises messages that are presented earlier than a normal time of presentation, wherein said existing content comprises unread or unflagged messages.
